(19) United States
(12) Patent Application Publication
(10) Pub. No.: US 2005/0066093 A1
(43) Pub. Date: Mar. 24, 2005

(54) Real-time processor system and control method

(76) Inventors: Ryuji Fuchikami, Kasuya-Gun (JP); Tomonori Yonezawa, Fukuoka (JP); Yoichi Nishida, Kasuya-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/942,893

(22) Filed: Sep. 17, 2004

(30) Foreign Application Priority Data
Sep. 19, 2003 (JP) 2003-328768

(51) Int. Cl. G06F 13/00

(52) U.S. Cl. 710/107

(57) ABSTRACT

A real time processor system comprises: a bus arbiter; a plurality of calculating units, each having a processor and an interruption processing unit; a DMA controller; a plurality of priority registers; a memory; and an SCI. The bus arbiter comprises: a priority comparing unit; and a bus assignment unit. Each of the plurality of priority registers stores an I/O access priority value corresponding to each of the calculating units. Priority values are compared, and then right of I/O use is determined. The values of the plurality of priority registers are changed, thereby adaptively performing multiple interruption processing.

### BACKGROUND OF THE INVENTION

1. Field of the Invention

The present invention relates to a real-time processor system and a control method thereof in environment where a plurality of bus masters arbitrate and use a bus.

2. Description of the Related Art

Conventionally, in providing real-time guarantee for software in environment where there is only one processor as a device that works as a bus master, the real-time guarantee is afforded by assigning priority per unit of processing and appropriately scheduling starting order for the processing.

For example, reference 1 (“HARD REAL-TIME COMPUTING SYSTEM, Predictable Scheduling Algorithms and Applications”, written by Giorgio C. Buttazzo, Fourth Printing 2002, Kluwer Academic Publishers, pp.109-146 and pp.149-178) discloses, in pages 109-146, that when fixed priority is given for each processing, a method that assigns higher priority to processing with shorter executing time is best suited in minimizing the maximum delay time from start request to the completion of a series of processing.

The reference 1 also discloses, in pages 149-178, that when dynamically changeable priority is given for each processing, a method that determines priority for each processing every time when new processing request occurs, and gives higher priority to processing with shorter time in the permissible deadline before the completion of each processing is best suited in minimizing the maximum delay time from start request to the completion of a series of processing.

Reference 2 (Japanese Patent Laid-Open No. 2001-125880) discloses, as a speeding-up method that can be applied only to interruption processing in a multi-processor configuration, a method that sends information indicating that an interruption has occurred in which processor to a bus arbiter, and temporarily raises the bus arbitration priority for the processor in which the interruption has occurred.

FIG. 14 is a block diagram illustrating a prior system that performs interruption processing. The system comprises an interruption processing circuit 1401, processors 1402 and 1403, a bus arbiter 1404, a memory 1407, and an SCI (Serial Communication Interface) 1408. The bus arbiter 1404 possesses a fixed priority setting unit 1405 and a bus assignment unit 1406.

When an interruption condition to interruption request from the outside is satisfied, the interruption processing circuit 1401 makes either the processor 1402 or the processor 1403 generate interruption according to the factor of the interruption request. At the same time, the interruption processing circuit 1401 requests the bus arbiter 1404 to change I/O access priority (access priority to an I/O device) to the fixed priority for the processor that has generated interruption.

The bus arbiter 1404 sets the fixed priority for the processor designated by the fixed priority setting unit 1405. Then, the bus assignment unit 1406 assigns an I/O access right preferentially to the processor that has generated the interrupt. In this way, the processing by the interruption request is executed with raised priority.

When the software scheduling theory of a single processor disclosed in the reference 1 is applied in hardware environment where the I/O device, which is shared by a plurality of processors and a plurality of devices, it is necessary to apply the theory to the determination method of priority in access arbitration for the hardware resource, such as the I/O device.

However, when program execution itself needs the I/O access, for example, when the program itself is stored in a memory that is one of the shared I/O devices, there is a striking delay in the program execution for changing the I/O access priority, since the I/O access is required for the program execution of interruption processing.

Even if the prior art which the reference 2 discloses is incorporated, the prior system configuration shown in FIG. 14 can provides only information in which processor the interrupt occurred as the information to be sent to a bus arbiter 1404, and moreover, the prior system configuration can send the information only at the time when the interruption occurs. This means that a change of the I/O access priority, such as raising the I/O access priority, can be made only to one bus master. Therefore, when another interruption occurs during the interruption processing generated previously (in a case of multiple interruption), the interruption processing generated later is performed with lower I/O access priority until the interruption processing generated previously is completed, thus delaying the processing generated later drastically.

In the system configuration shown in FIG. 14, since it is necessary to send the information to the bus arbiter 104 by an event that indicates in which processor the interruption occurs, it is necessary to manage interruption occurrence situation by one portion in the system. Therefore, an interruption controller cannot be arranged individually for every processor.

Furthermore, in the system configuration shown in FIG. 14, since only the temporary rise of the I/O access priority can be performed at the time when the interruption occurs, the incorporation of the art disclosed by the patent reference 1 to the system configuration necessitates to integrate the real-time processing in the interruption processing portion of the software. Therefore, a communicative mechanism that provides cooperative operation among processors is additionally needed, in order to adaptively control bus arbitration priority, according to the contents of processing other than interruption processing.

### OBJECTS AND SUMMARY OF THE INVENTION

An object of the present invention is to provide a real-time processing and a control method thereof operable to providing every bus master with individual interruption processing means, and operable to adaptively control bus arbitration priority for both of multiple interruption and processing other than interruption processing, in the environment where a plurality of bus masters arbitrate and uses a bus.

A first aspect of the present invention provides a real-time processor system comprising: a plurality of function groups; a bus arbiter; and at least one I/O device operable to connect to the bus arbiter. Each of the plurality of function groups comprises: a calculating unit comprising a processor and an interruption processing unit, the calculating unit being operable to connect to the bus arbiter; and a priority register operable to store either one of an I/O access priority value for ordinary processes by the processor and an I/O access priority value for interruption processes by the interruption processing unit. The bus arbiter comprises: a priority comparing unit operable to compare a plurality of priority values respectively stored in the priority register of each of the plurality of function groups, thereby outputting a comparison result; and a bus assignment unit operable to decide access right to a bus based on the comparison result.

According to the present structure, since it is possible to provide a priority register for each processor and to determine an access right comparing priority for each bus master, the change of priority for a processor, in which the interruption has generated later, can be immediately reflected to the access right judgment even when the interrupt occurs at another processor during the interruption processing at a certain processor.

Since an interruption processing unit can be operated separately for every processor, multiple interruption processing becomes easier.

Furthermore, only by changing the contents of the priority register corresponding to a processor, the access right judgment in the bus arbitration among the processor and other bus masters can be easily changed. Therefore, the processor can adjust the ratio of the I/O access frequency for every bus master without performing synchronized processing with other bus masters.

A second aspect of the present invention provides a real-time processor system comprising: at least one function group; a bus arbiter; at least one I/O device operable to connect to the bus arbiter, a bus access generation unit operable to connect to the bus arbiter and to actively generate bus access; and a first priority register operable to store a bus access priority value for the bus access generation unit. The at least one function group comprises: a calculating unit comprising a processor and an interruption processing unit, the calculating unit being operable to connect to the bus arbiter; and a second priority register operable to store either one of an I/O access priority value for ordinary processes by the processor and an I/O access priority value for interruption processes by the interruption processing unit. The bus arbiter comprises: a priority comparing unit operable to compare a priority value stored in the first priority register with a priority value stored in the second priority register to output a comparison result; and a bus assignment unit operable to decide access right to a bus based on the comparison result.

According to the present structure, it is possible to provide a real-time processor system which shares I/O devices and bus access generating units: the I/O devices may includes such as a memory device and an SCI (serial communication interface), and the bus access generating units may include such as a DMA controller which connects with a bus arbiter and carries out direct access to the I/O devices. In other words, it is possible to provide a real-time processor system in which a time guarantee is realized, by securing cooperation between real-time processing by software and non-real-time processing not by software, even if the I/O devices and the bus access generating units are shared.

A third aspect of the present invention provides a real-time processor system comprising: at least one function group; a bus arbiter; at least one I/O device operable to connect to the bus arbiter; a bus access generation unit operable to connect to the bus arbiter and to actively generate bus access; and a first priority register operable to store a bus access priority value for the bus access generation unit. The at least one function group comprises: a calculating unit comprising a processor and an interruption processing unit, the calculating unit being operable to connect to the bus arbiter; a second priority register operable to store either one of an I/O access priority value for ordinary processes by the processor and an I/O access priority value for interruption processes by the interruption processing unit; and a comparison storing unit operable to compare an I/O access priority value for interruption processes by the interruption processing unit with an I/O access priority value stored in the second priority register, the comparison storing unit further being operable to store the I/O access priority value for the interruption processes by the interruption processing unit into the second register only when the I/O access priority value for the interruption processes by the interruption processing unit indicates higher priority than the I/O access priority value that has been stored in the second register. The bus arbiter comprises: a priority comparing unit operable to compare a priority value stored in the first priority register with a priority value stored in the second priority register to output a comparison result; and a bus assignment unit operable to decide access right to a bus based on the comparison result.

According to the present structure, when the interruption processing unit sets new priority to a priority register, the new priority is compared with the priority already stored in the priority register, and stored in the priority register only when the priority rises.

Therefore, if normal processing other than interruption processing possesses I/O access priority that is higher than the I/O access priority of the interruption processing, the I/O access priority for the normal processing is not lowered by the interruption processing. This means that the processor can perform the normal processing with higher priority than the interruption processing.

A fourth aspect of the present invention provides a real-time processor system comprising: at least one function group; a bus arbiter; at least one I/O device operable to connect to the bus arbiter; a bus access generation unit operable to connect to the bus arbiter and to actively generate bus access; and a first priority register operable to store a bus access priority value for the bus access generation unit. The at least one function group comprises: a calculating unit comprising a processor and an interruption processing unit, the calculating unit being operable to connect to the bus arbiter; a second priority register operable to store either one of an I/O access priority value for ordinary processes by the processor and an I/O access priority value for interruption processes by the interruption processing unit; and a priority changing unit operable to change as time passes the I/O access priority value stored in the second priority register so that the I/O access priority value stored in the second priority register indicates higher priority. The bus arbiter comprises: a priority comparing unit operable to compare a priority value stored in the first priority register with a priority value stored in the second priority register to output a comparison result; and a bus assignment unit operable to decide access right to a bus based on the comparison result.

According to the present structure, the priority register can be provided with a means that makes the priority rise as the time passes. Even in environment where a series of processing with high priority must be performed continuously, it is possible to avoid such an unfavorable situation that processing with lower priority cannot acquire I/O access right forever due to a continuous execution of the series of processing with high priority.

A fifth aspect of the present invention provides a real-time processor system as defined in the first aspect, wherein the calculating unit of each of the plurality of function groups further comprises a storing unit operable to store into the priority register an I/O access priority value uniquely determined by an interruption factor.

According to the present structure, the interruption processing unit can annex a means that provides a priority setup corresponding to the interruption factor. Therefore, when the I/O access priority needs to be changed according to the interruption factor, factor judgment in software becomes unnecessary; therefore, the processing can be executed at high speed.

A sixth aspect of the present invention provides a real-time processor system as claimed in the fifth aspect, wherein the storing unit comprises a group of priority setting registers, one of the priority setting registers pre-storing an I/O access priority value that is program-controlled by the processor, and another of the priority setting registers pre-storing an I/O access priority value that is determined by an interruption factor, and wherein, only when a new interruption is requested and an I/O access priority value determined by an interruption factor of the new interruption indicates higher priority than a priority value of an interruption under processing, the storing unit stores into the priority register the I/O access priority value determined by the interruption factor of the new interruption.

According to the present structure, when an I/O access priority needs to be changed according to an interruption factor, the interruption processing can be executed at high speed by a register processing.

A seventh aspect of the present invention provides a controlling method for a real-time processor system, the controlling method comprising: searching a task to be next performed; storing, in a priority register corresponding to an executing processor, an I/O access priority value of the task detected in the searching; and changing a current task to the task detected in the searching.

A eighth aspect of the present invention provides a controlling method as claimed in the seventh aspect, wherein the real-time processor system comprising: a plurality of function groups; a bus arbiter; and at least one I/O device operable to connect to the bus arbiter, wherein each of the plurality of function groups comprises: a calculating unit comprising a processor and an interruption processing unit, the calculating unit being operable to connect to the bus arbiter; and a priority register operable to store either one of an I/O access priority value for ordinary processes by the processor and an I/O access priority value for interruption processes by the interruption processing unit. The bus arbiter comprises: a priority comparing unit operable to compare a plurality of priority values respectively stored in the priority register of each of the plurality of function groups, thereby outputting a comparison result; and a bus assignment unit operable to decide access right to a bus based on the comparison result.

According to these methods, since the priority register can be set up between execution task determination and task switching in the operating system, application software needs to set up the priority only at the time of starting, therefore, software control can be integrated in the operating system. Consequently, program design becomes possible for application software that operates on the operating system with higher portability.

A ninth aspect of the present invention provides a controlling method for a real-time processor system, the controlling method comprising: searching a task to be next performed; calculating a remaining time that is a time difference between a dead line corresponding to the task detected in the searching and a current time; storing, in a priority register corresponding to an executing processor, an I/O access priority value corresponding to the remaining time calculated in the calculating; and changing a current task to the task detected in the searching.

A tenth aspect of the present invention provides a controlling method as defined in the ninth aspect, wherein the real-time processor system comprising: a plurality of function groups; a bus arbiter; and at least one I/O device operable to connect to the bus arbiter, wherein each of the plurality of function groups comprises: a calculating unit comprising a processor and an interruption processing unit, the calculating unit being operable to connect to the bus arbiter; and a priority register operable to store either one of an I/O access priority value for ordinary processes by the processor and an I/O access priority value for interruption processes by the interruption processing unit. The bus arbiter comprises: a priority comparing unit operable to compare a plurality of priority values respectively stored in the priority register of each of the plurality of function groups, thereby outputting a comparison result; and a bus assignment unit operable to decide access right to a bus based on the comparison result. The calculating unit of each of the plurality of function groups further comprises a storing unit operable to store into the priority register an I/O access priority value uniquely determined by an interruption factor. The storing unit comprises a group of priority setting registers, one of the priority setting registers pre-storing an I/O access priority value that is program-controlled by the processor, and another of the priority setting registers pre-storing an I/O access priority value that is determined by an interruption factor. Only when a new interruption is requested and an I/O access priority value determined by an interruption factor of the new interruption indicates higher priority than a priority value of an interruption under processing, the storing unit stores into the priority register the I/O access priority value determined by the interruption factor of the new interruption.

According to these methods, calculation of permitted remaining time up to the processing completion and set-up for the priority register can be done between the execution task determination and the task change of the operating system. This means that the application software only needs to set up the deadline time up to the processing completion at the time of starting. Therefore, software control can be integrated in the operating system. Consequently, program design becomes possible for application software that operates on the real-time operating system with higher portability.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of a real-time processor system in a first embodiment of the present invention;

FIG. 2 is a block diagram of a real-time processor system in a second embodiment of the present invention;

FIG. 3 is a block diagram of a real-time processor system in a third embodiment of the present invention;

FIG. 4 is a block diagram of a real-time processor system in a fourth embodiment of the present invention;

FIG. 5 is a flowchart of processing for a controlling method in a fifth embodiment of the present invention;

FIG. 6 is a flowchart of processing for a controlling method in a sixth embodiment of the present invention;

FIG. 7 is a time chart of the real-time processor system in the first embodiment of the present invention;

FIG. 8 is a time chart when performing multiple interruption processing in the real-time processor system in the first embodiment of the present invention;

FIG. 9 is a time chart of the real-time processor system in the second embodiment of the present invention;

FIG. 10(a) is a time chart when the real-time processor system in the third embodiment of the present invention performs a priority-succeeded interruption processing;

FIG. 10(b) is a time chart when the real-time processor system in the third embodiment of the present invention performs priority-unsucceeded interruption processing;

FIG. 11 is a time chart of the real-time processor system in the fourth embodiment of the present invention;

FIG. 12 is a time chart of processing for the controlling method in the fifth embodiment of the present invention;

FIG. 13 is a time chart of processing for the controlling method in the sixth embodiment of the present invention; and

FIG. 14 is a block diagram of a prior system that performs interruption processing.

### DETAILED DESCRIPTION OF THE PREFERRED EMBODIMENTS

Hereinafter, embodiments of the present invention are described with reference to the accompanying drawings.

### First Embodiment

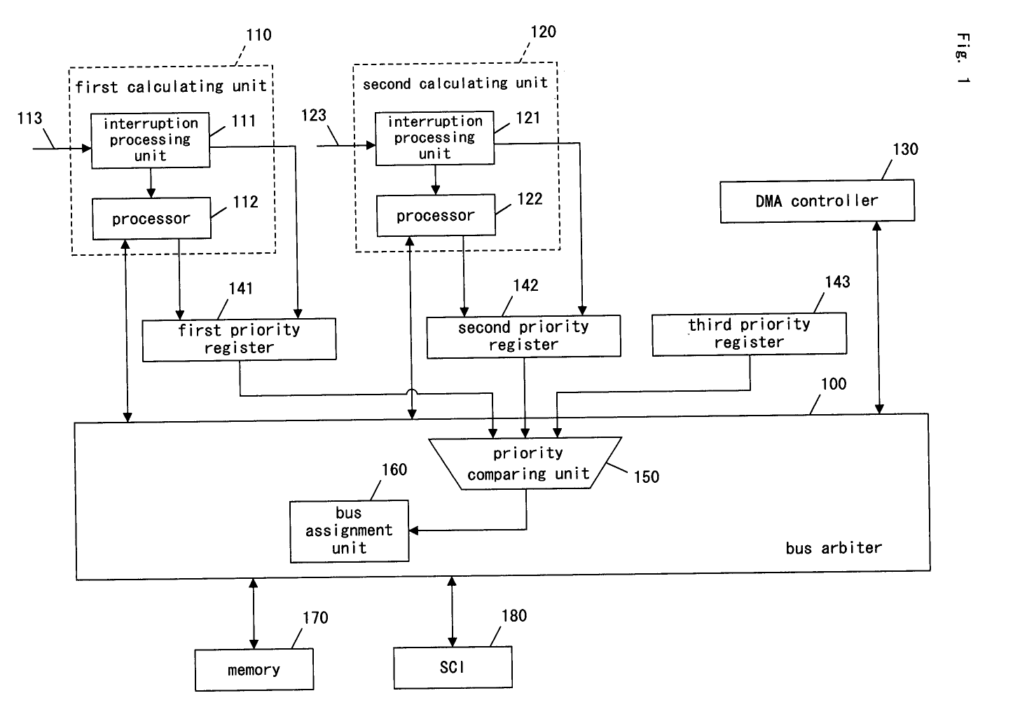

FIG. 1 is a block diagram of a real-time processor system in a first embodiment of the present invention.

The real-time processor system of the present embodiment comprises a bus arbiter 100, a first calculating unit 110, a second calculating unit 120, a DMA controller 130, a first priority register 141, a second priority register 142, a third priority register 143, a memory 170, and an SCI (Serial Communication Interface) 180.

The first calculating unit 110 includes an interruption processing unit 111 and a processor 112, the second calculating unit 120 includes an interruption processing unit 121 and a processor 122, and the bus arbiter 100 includes a priority comparing unit 150 and a bus assignment unit 160. The first priority register 141 stores the I/O access priority value of the first calculating unit 110, and the second priority register 142 stores the I/O access priority value of the second calculating unit 120. The third priority register 143 stores a fixed value as a DMA processing priority value of the DMA controller 130.

The first calculating unit 110 and the first priority register 141 belong to a first function group and the second calculating unit 120 and the second priority register 142 belong to a second function group. The third priority register 143 corresponds to a first priority register and the first priority register 141 and the second priority register 142 correspond to a second priority register, as described above and defined in the aspects of the present invention.

The DMA controller 130 corresponds to a bus access generating unit, and the memory 170 and the SCI 180 correspond to I/O devices, as described above and defined in the aspects of the present invention.

Next, operation of the real-time processor system of the present embodiment is explained referring to FIG. 1.

It is defined that the smaller the priority value is, the higher the I/O access priority is in the real-time processor system of the present embodiment.

In the real-time processor system of the present embodiment, it is assumed that the regular processing executed in the processor 112 possesses a priority value “5”, the interruption processing executed in the processor 112 possesses a priority value “2”, the regular processing executed in the processor 122 possesses a priority value “4”, the interruption processing executed in the processor 122 possesses a priority value “1”, the processing for the DMA controller 130 set to and fixed in the priority register 143 possesses a priority value “3”. It is further assumed that the smaller the value is, the higher the priority is.

When the real-time processor system of the present embodiment starts the operation, the priority value “5” necessary for the I/O access of the processor 112 is written in the first priority register 141 by the program that operates on the processor 112. The priority value “4” necessary for the I/O access of the processor 122 is written in the second priority register 142 by the program that operates on the processor 122. The priority value “3” is set to and fixed in the third priority register 143.

When the bus arbiter 100 receives the request of I/O access from a device used as a bus master (they are the processor 112, the processor 122, and the DMA controller 130 in the present embodiment as shown in FIG. 1), the priority comparing unit 150 compares the priority values stored in the first priority register 141, the second priority register 142, and the third priority register 143, and determines a request with the highest priority. The bus assignment unit 160 gives I/O access right preferentially to a request with the highest priority based on the result. Therefore, at the time of operation start, the DMA controller 130, which has the priority value “3” and the highest priority, can perform the I/O access most preferentially.

Next, during the operation, when an interruption condition to the interruption input 113 is established in the interruption processing unit 111, the interruption processing unit 111 branches the program execution of the processor 112 at the interruption processing, and writes an I/O access priority value “2” for the interruption processing in the first priority register 141. At this stage, the processor 112 is in the status that it can perform the I/O access most preferentially, and can execute interruption processing at high speed.

Subsequently, when an interruption condition to the interruption input 123 is established in the interruption processing unit 121, the interruption processing unit 121 branches the program execution of the processor 122 at the interruption processing, and writes an 110 access priority value “1” for interruption processing in the second priority register 142. At this stage, the processor 112 has not completed the interruption processing yet. However, since the processor 122 is in the status that it can perform the I/O access most preferentially, the interruption processing of the processor 122, whose priority is higher than that for the interruption processing of the processor 112, becomes possible to execute without delay.

When the interruption processing of the processor 122 is completed, the program, which has performed the interruption processing of the processor 122, writes a priority value “4” for the regular program in the second priority register 142, and returns from interruption. At this stage, the processor 112 can perform the I/O access most preferentially again, and the remaining interruption processing is executed at high speed.

When the interruption processing of the processor 112 is completed, the program, which has performed the interruption processing of the processor 112, writes a priority value “5” for the regular program in the first priority register 141, and returns from interruption.

At this stage, the DMA controller 130 returns to the status that it can perform the 110 access most preferentially again.

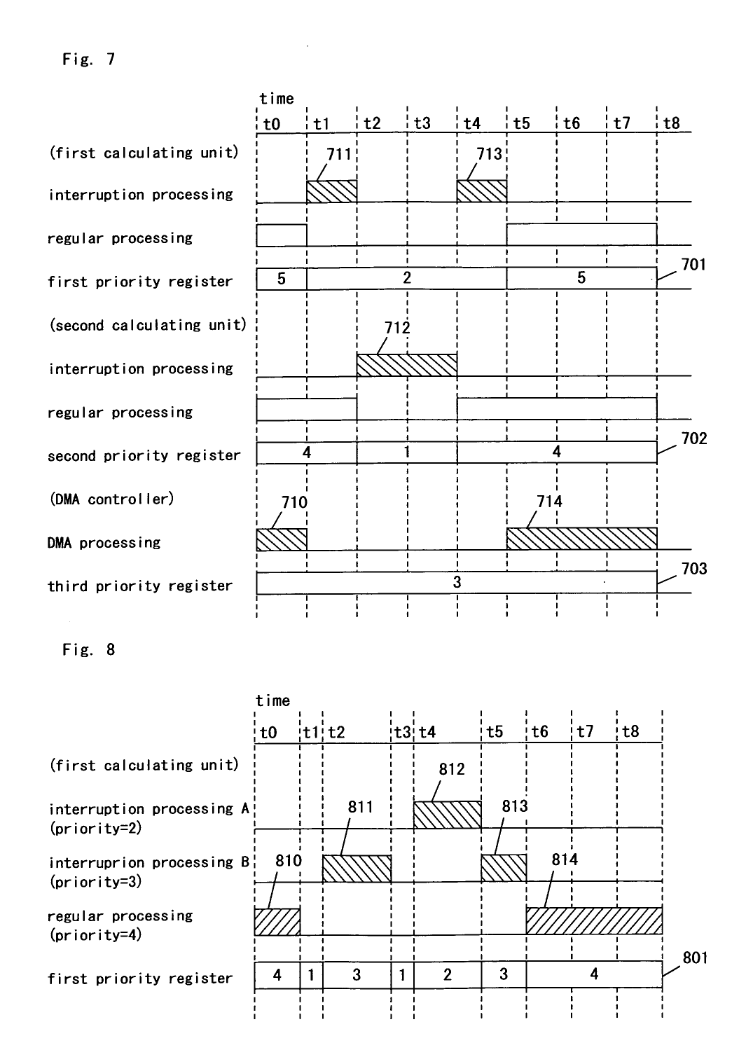

FIG. 7 is a time chart of the real-time processor system in the first embodiment of the present invention. In connection with the interruption processing mentioned above, an example of the scheduling of the I/O access, which the bus arbiter 100 performs, is described referring to FIG. 1 and FIG. 7 in the following.

The horizontal axis of FIG. 7 is time, and priority values 701, 702, and 703 are priority values stored in the first priority register 141, the second priority register 142, and the third priority register 143, respectively. The slashed area indicates the processing that is performed with the highest priority in each time as the interruption processing or DMA processing.

DMA processing 710 is executed at time t0, interruption processing 711 of the first calculating unit 110 is executed at time t1, interruption processing 712 of the second calculating unit 120 is executed at time t2 and t3, remaining interruption processing 713 of the first calculating unit 110 is executed at time t4, and DMA processing 714 is executed at time t5 to t7.

Even when no interruption is generated, when the amount of data processed by the processor 122 is decreased, the processor 122 writes the priority value “6” in the second priority register 142; therefore, more I/O access right can be scheduled for the processor 112. When the amount of data has increased again for the processor 122, the processor 122 writes the priority value “4” in the second priority register 142; therefore, the scheduling of the I/O access right is back to the same status as the time of starting.

Thus, the bus arbiter 100 performs the scheduling of the I/O access to the device used as a bus master.

In the real-time processor system of the present embodiment, multiple interruption processing is executed by the program on the processor 112 or the processor 122.

FIG. 8 shows an example when multiple interruption is generated in the first calculating unit 110. FIG. 8 is a time chart when performing multiple interruption processing in the real-time processor system in the first embodiment of the present invention.

Explanation will be done referring to FIG. 1 and FIG. 8. At time t0, a priority value 801 of the first priority register 141 is a value “4”, and regular processing 810 is executed.

At time t1, the interruption processing unit 111 writes a priority value “1” in the first priority register 141 when the interruption input 113 is received to execute an interruption processing B. The processor 112 judges the factor of the interruption input 113 for the interruption processing B, and writes a priority value “3” in the first priority register 141. At time t2, an interruption processing B 811 is executed as a result of arbitration of the bus arbiter 100.

During the execution of the interruption processing B 811, at time t3, the interruption processing unit 111 receives interruption input 113 to execute a new interruption processing A, and writes the priority value “1” in the first priority register 141. The processor 112 judges the factor of the interruption input 113 for the interruption processing A, and writes the priority value “2” in the first priority register 141. At time t4, an interruption processing A 812 is executed as a result of arbitration of the bus arbiter 100.

After the interruption processing A 812 is completed, the processor 112 writes the priority value “3” of the discontinued interruption processing A in the first priority register 141. As a result of the arbitration of the bus arbiter 100, at time t5, an interruption processing A 813 is resumed and executed continuously.

After the interruption processing A 813 is completed, the processor 112 writes the priority value “4” of the discontinued regular processing in the first priority register 141. As a result of the arbitration of the bus arbiter 100, at time t6 to t8, regular processing 814 is executed continuously.

The priority value in the explanation of the present embodiment mentioned above is an example, and any other values may by set up arbitrarily.

### Second Embodiment

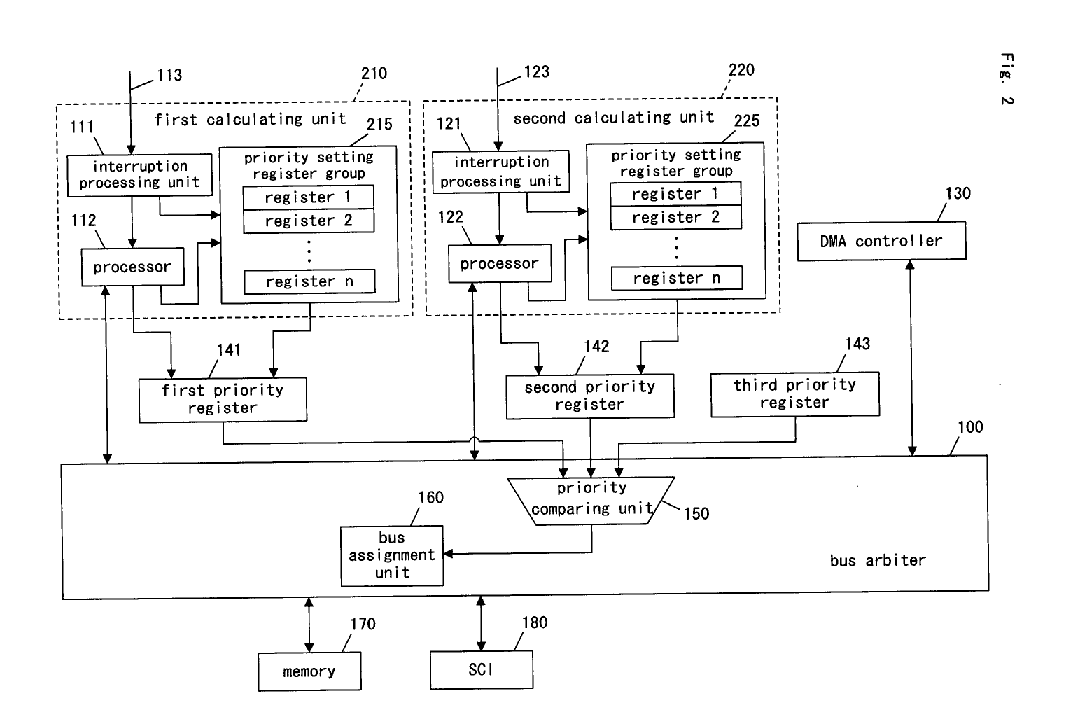

FIG. 2 is a block diagram of a real-time processor system in a second embodiment of the present invention. In FIG. 2, descriptions are omitted by giving the same symbols regarding the same components as in FIG. 1.

The real-time processor system of the present embodiment shown in FIG. 2 comprises the bus arbiter 100, a first calculating unit 210, a second calculating unit 220, the DMA controller 130, the first priority register 141, the second priority register 142, the third priority register 143, the memory 170, and the SCI 180. The first calculating unit 210 includes the interruption processing unit 111, the processor 112, and a priority setting register group 215. The second calculating unit 220 includes the interruption processing unit 121, the processor 122, and a priority setting register group 225.

The first calculating unit 210 and the first priority register 141 belong to a first function group and the second calculating unit 220 and the second priority register 142 belong to a second function group. The third priority register 143 corresponds to a first priority register and the first priority register 141 and the second priority register 142 correspond to a second priority register, as described above and defined in the aspects of the present invention.

The DMA controller 130 corresponds to a bus access generating unit, and the memory 170 and the SCI 180 correspond to I/O devices, as described above and defined in the aspects of the present invention.

It is defined that the smaller the priority is the higher the I/O access priority is in the real-time processor system of the present embodiment.

The priority setting register group 215 and the priority setting register group 225 have respectively a plurality of registers, and can set up beforehand two or more I/O access priority values corresponding to the interruption factors at the time of interruption processing.

The program executed on the processor 112 can write the I/O access priority value in the register within the priority setting register group 215.

The program executed on the processor 122 can write the I/O access priority value in the register within the priority setting register group 225.

When the interruption condition to the interruption input 113 is established in the interruption processing unit 111, the interruption processing unit 111 reads out the I/O access priority value corresponding to the factor of the interruption input 113 from the priority setting register group 215. Even if the processor 112 is already processing interruption, when the I/O access priority value corresponding to the interruption factor newly generated is higher in priority than the I/O access priority value corresponding to the factor of the interruption processing that is already in progress, the interruption processing unit 111 reads out the I/O access priority value corresponding to the new interruption factor from the priority setting register group 215, writes the value in the first priority register 141, and issues multiple interruption to the processor 112.

The interruption processing in the second calculating unit 220 and multiple interruption processing are the same as those of the case in the first calculating unit 210.

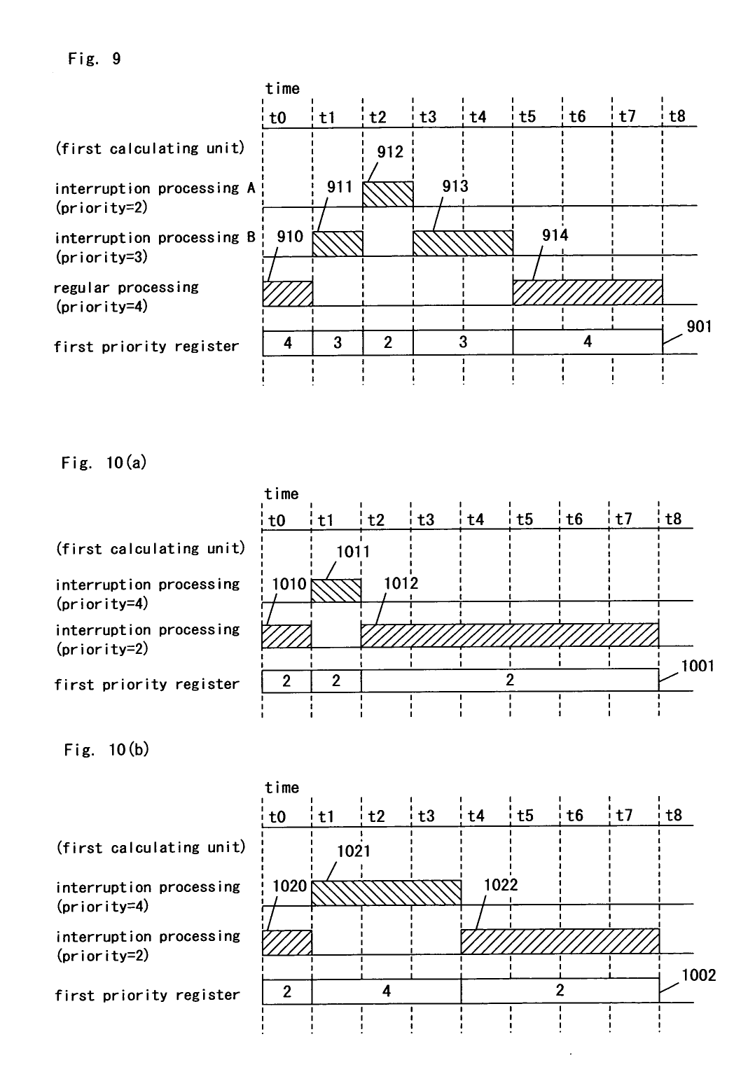

FIG. 9 is a time chart of the real-time processor system in the second embodiment of the present invention. FIG. 9 shows an example of the scheduling for the I/O access, which the bus arbiter 100 performs in connection with the multiple interruption processing mentioned above. In this case, the example only concerns the first calculating unit 210.

The horizontal axis of FIG. 9 is time, and a priority value 901 expresses the priority value of each time stored in the first priority register 141. It is assumed that the interruption processing A has the priority value “2”, the interruption processing B has the priority value “3”, and the regular processing has the priority value “4”. The priority values are beforehand stored in the corresponding registers in the priority setting register group 215 shown in FIG. 2.

In the following, the outline of operation for the real-time processor system of the present embodiment is explained referring to FIG. 2 and FIG. 9.

A regular processing 910 is performed at time to.

At time t1, the interruption request of the interruption processing B to the interruption processing unit 111 is made, and the interruption processing unit 111 reads out the priority value “3” from a register corresponding to the above interruption factor in the registers of the priority setting register group 215, and writes the value in the first priority register 141. Simultaneously, an interruption processing B 911 is executed.

At time t2, a new interruption request of the interruption processing A is made to the interruption processing unit 111. The interruption processing unit 111 reads out the priority value “2” of the interruption processing A from the priority setting register group 215, compares the value with the priority value “3” of the interruption processing B under execution, checks that the priority of the interruption processing A is higher, and writes the priority value “2” of the interruption processing A in the first priority register 141. Then, the interruption processing B 911 is discontinued, and a new interruption processing A 912 is executed.

After the interruption processing A 912 is completed, at time t3, the processor 112 compares the priority value of the interruption processing B, which has been discontinued, with the priority value of the regular processing, and writes, in the first priority register 141, the priority value “3” of the interruption processing B as a task with higher priority. Then, interruption processing B 913, which has been discontinued, is executed at time t3 to t4.

After the interruption processing B 913 is completed, at time t5, the processor 112 writes the priority value “4” of the regular processing, which is a task under discontinuation, in the first priority register 141. Then, a regular processing 914, which has been discontinued, is executed at time t5 to t7.

Thus, the real-time processor system of the present embodiment can execute multiple interruption processing efficiently mainly by hardware. Comparing with the real-time processor system in the first embodiment of the present invention, the real-time processor system of the present embodiment exhibits feature that the processing amount for the multiple interruption processing in the processor is much more reduced, thereby the system can execute multiple interruption processing more efficiently.

### Third Embodiment

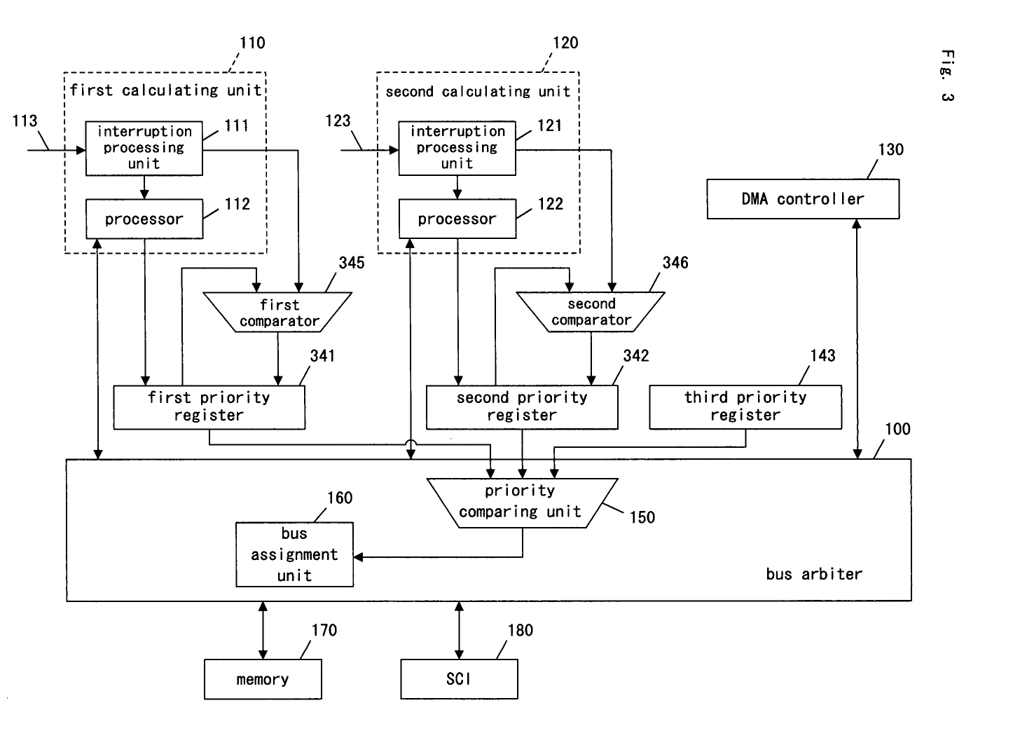

FIG. 3 is a block diagram of a real-time processor system in a third embodiment of the present invention. In FIG. 3, descriptions are omitted by giving the same symbols regarding the same components as in FIG. 1.

The real-time processor system of the present embodiment shown in FIG. 3 comprises the bus arbiter 100, the first calculating unit 110, the second calculating unit 120, the DMA controller 130, a first priority register 341, a first comparator 345, a second priority register 342, a second comparator 346, the third priority register 143, the memory 170, and the SCI 180.

The bus arbiter 100 includes the priority comparing unit 150 and the bus assignment unit 160.

The first calculating unit 110, the first priority register 341, and the first comparator 345 belong to a first function group. The second calculating unit 120, the second priority register 342, and the second comparator 346 belong to a second function group. The third priority register 143 corresponds to a first priority register and the first priority register 341 and the second priority register 342 correspond to a second priority register, as described above and defined in the aspects of the present invention.

The DMA controller 130 corresponds to a bus access generating unit, and the memory 170 and the SCI 180 correspond to I/O devices, as described above and defined in the aspects of the present invention.

The first comparator 345 inputs a priority value currently stored in the first priority register 341 and a priority value from the interruption processing unit 111 accompanying new interruption, compares these values, selects the priority value with higher priority, and stores the selected priority value in the first priority register 341. Namely, by combining the first priority register 341 and the first comparator 345, only when the priority of the new interruption processing is higher than the priority stored in the first priority register 341, the priority value of the first priority register 341 is changed.

The performance of the combination of the second priority register 342 and the second comparator 346 is the same.

In the following, an outline of the real-time processor system of the present embodiment is explained focusing on different points from the first and second embodiments.

It is defined in the real-time processor system of the present embodiment that the smaller the priority value is, the higher the I/O access priority is.

When the interruption processing unit 111 of the first calculating unit 110 receives the interruption input 113 and writes a priority value corresponding to the interruption input 113 in the first priority register 341, the first comparator 345 compares the priority value corresponding to the interruption input 113 with the I/O access priority value that has been stored in the first priority register 341 and, and writes a priority value with higher priority (or a smaller priority value) in the first priority register 341.

The same processing is also performed in the second calculating unit 120, the second priority register 342, and the second comparator 346.

The third priority register 143 is a register, which sets up and fixes the priority value for the DMA controller 130.

The real-time processor system of the present embodiment exhibits remarkable performance when it executes the interruption processing with lower I/O access priority compared with the I/O access priority of the regular processing.

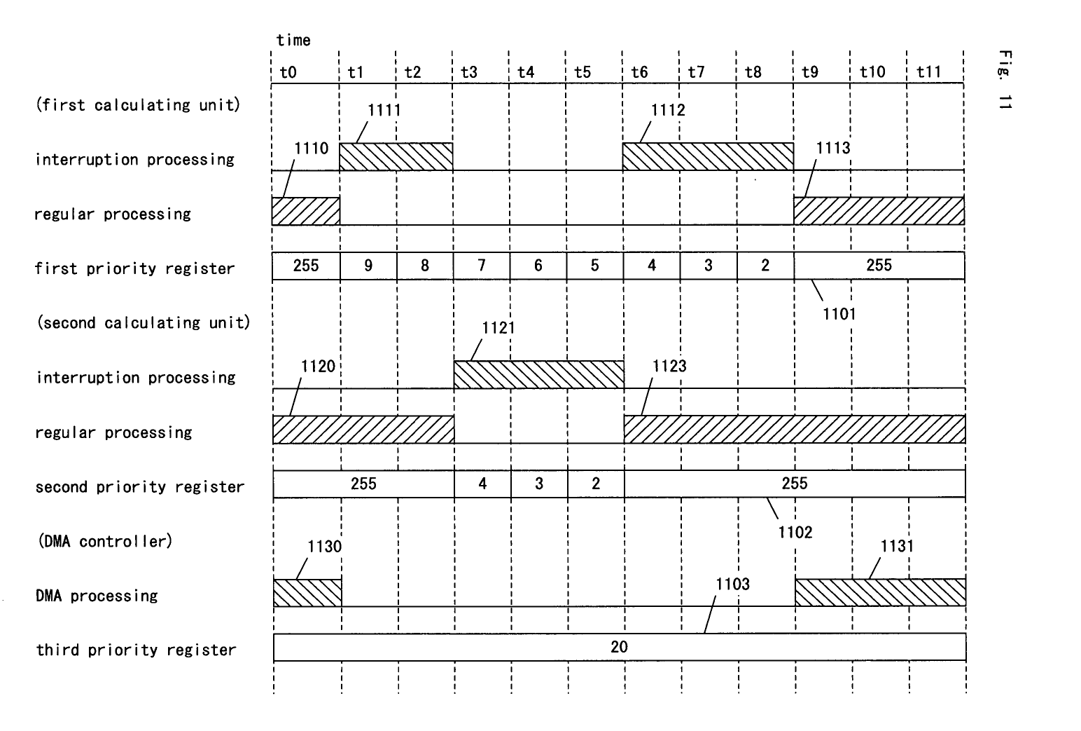

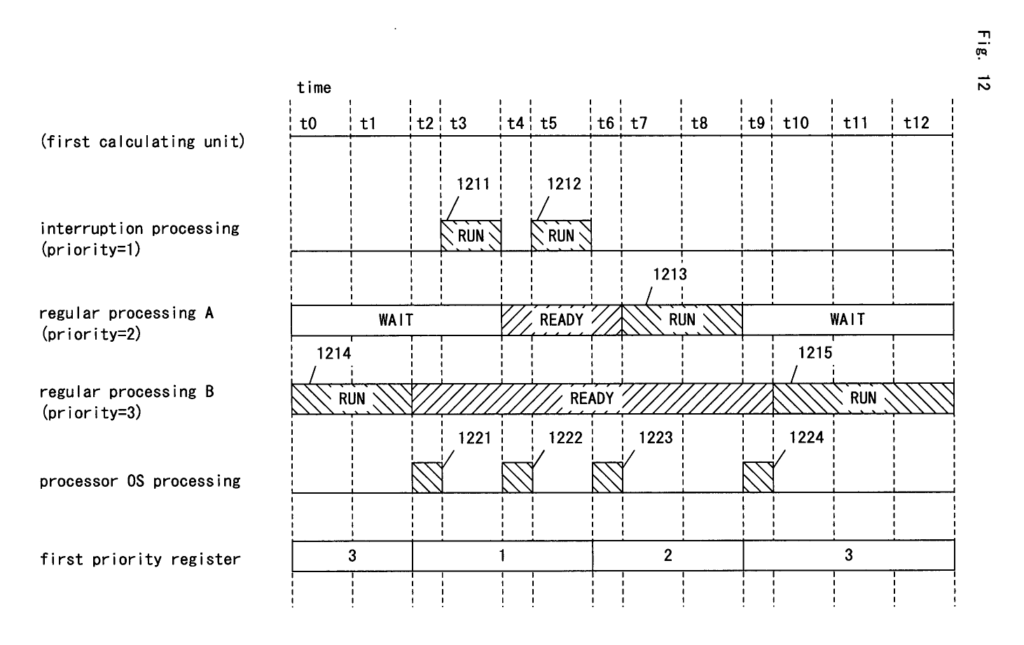

FIG. 10(a) is a time chart when the real-time processor system in the third embodiment of the present invention performs the priority-succeeded interruption processing.

In the following, operation of the real-time processor system of the present embodiment is explained, focusing on the first calculating unit 110 shown in FIG. 3, and also referring to FIG. 10(a).

At time t0, the first calculating unit 110 executes regular processing 1010 with the priority value “2”. When the interruption processing unit 111 receives an interruption request for interruption processing with the priority value “4”, the priority value “4” for the interruption processing is compared with the priority value “2” of the processing under execution by the first comparator 345. After the comparison, the priority value “2” with the higher priority is written in the first priority register 341 (in this example, the content of the first priority register 314 is not changed by chance), and the processing of the processor 112 is switched to the interruption processing. At time t1, the interruption processing 1011 is processed with the priority value “2” as a result of arbitration of the bus arbiter 100.

After the interruption processing 1011 is completed, the processor 112 writes the priority value “2” of the discontinued regular processing in the first priority register 341 (also in this case, the content of the first priority register 314 is not changed by chance). At time t2 to t7, the regular processing 1012 is processed with the priority value “2” as a result of arbitration of the bus arbiter 100.

Consequently, in spite of the allotted low priority of the interruption processing from the beginning, the interruption processing can be processed with a higher priority by succeeding the priority of the processing that has already being executed.

Such processing is called as priority-succeeded interruption processing.

FIG. 10(b) is a time chart when the real-time processor system in the third embodiment of the present invention performs priority-unsucceeded interruption processing. FIG. 10(b) illustrates the real-time processor system, which disables the function of the first comparator 345 to make the interruption processing be performed at the highest priority. FIG. 10(b) is illustrated to be compared with FIG. 10(a) mentioned above.

In FIG. 10(b), since the succession of a priority is not performed to the interruption processing, at time t1, the priority value stored in the first priority register 341 is changed into the priority value “4” for the interruption processing. Therefore, at time t1 to t3, the interruption processing 1021 is executed as a result of arbitration of the bus arbiter 100. Since the interruption processing 1021 is executed with lower priority, longer process time is necessary for the processing.

After the interruption processing 1021 is completed, the processor 112 writes the priority value “2” of the discontinued regular processing in the first priority register 341. At time t4 to t7, the regular processing 1022 is processed with the priority value “2” as a result of arbitration of the bus arbiter 100.

As clearly shown in comparison between FIG. 10(a) and FIG. 10(b), the real-time processor system of the present embodiment possesses remarkable performance when it executes the interruption processing with lower I/O access priority compared with the I/O access priority of the regular processing. At the same time, it means that the I/O access priority of the regular processing can be set up higher than the I/O access priority of the interruption processing, thereby flexibility is increased in software design.

The real-time processor system of the present embodiment can be applied by combining with the second embodiment of the present invention, and the combined system may enjoy the effects that the systems in both embodiments possess.

### Fourth Embodiment

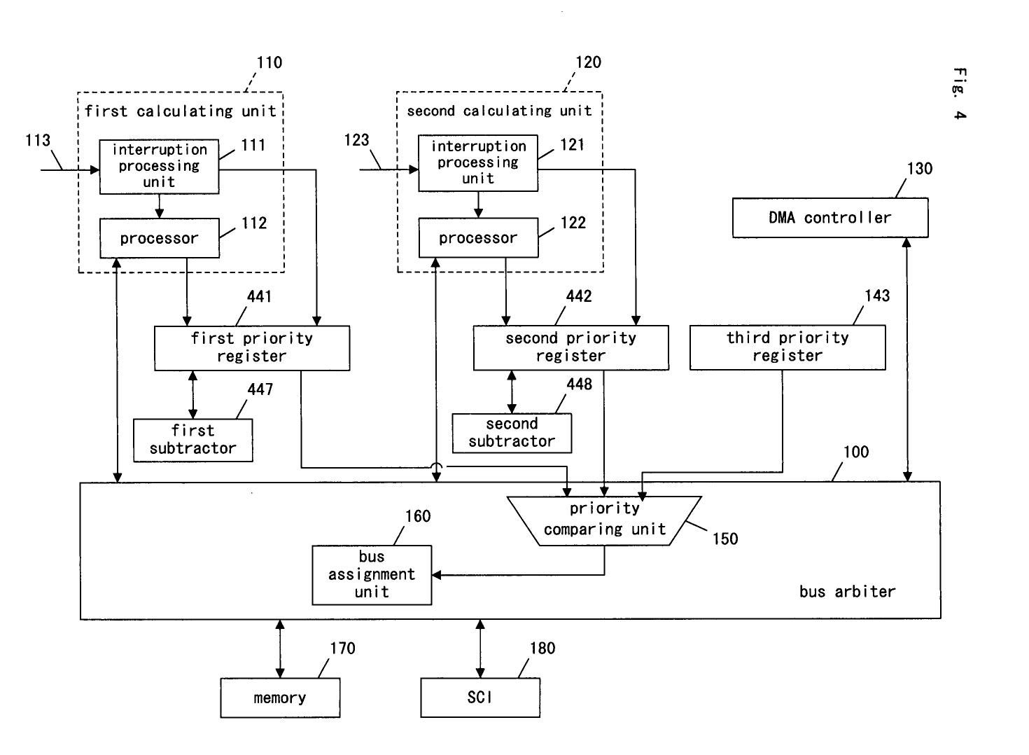

FIG. 4 is a block diagram of a real-time processor system according to a fourth embodiment of the present invention. In FIG. 4, descriptions are omitted by giving the same symbols regarding the same components as in FIG. 1.

As shown in FIG. 4, the real-time processor system of the present embodiment comprises the bus arbiter 100, the first calculating unit 110, the second calculating unit 120, the DMA controller 130, a first priority register 441, a first subtractor 447, a second priority register 442, a second subtractor 448, the third priority register 143, the memory 170, and the SCI 180. The bus arbiter 100 has the priority comparing unit 150 and the bus assignment unit 160.

The first calculating unit 110, the first priority register 441, and the first subtractor 447 belong to a first function group. The second calculating unit 120, the second priority register 442, and the second subtractor 448 belong to a second function group. The third priority register 143 corresponds to a first priority register and the first priority register 441 and the second priority register 442 correspond to a second priority register, as described above and defined in the aspects of the present invention.

The DMA controller 130 corresponds to a bus access generating unit, and the memory 170 and the SCI 180 correspond to I/O devices, as described above and defined in the aspects of the present invention.

In the real-time processor system of the present embodiment, it is defined that the smaller the priority value is, the higher the I/O access priority is.

The first subtractor 447 and the second subtractor 448 decrease the priority values stored in the first priority register 441 and the second priority register 442, respectively, until they reach predetermined values in a certain time interval. Hence, the first subtractor 447 and the second subtractor 448 act to raise the priority of the first priority register 441 and the second priority register 442 with time, respectively.

The third priority register 143 is a register which sets the priority value fixed for the DMA controller 130.

An example of operation of the real-time processor system of the present embodiment is described hereinafter using FIG. 11. FIG. 11 is a time chart of the real-time processor system according to the fourth embodiment of the present invention.

In this example, the first subtractor 447 is arranged such that when the priority value stored in the first priority register 441 is equal to or smaller than a subtraction threshold value “127” (this value can be set arbitrarily), the first subtractor 447 reduces the priority value stored in the first priority register 441 by “1” for every predetermined period of time. When the priority value stored in the first priority register 441 is greater than the subtraction threshold value “127”, the first subtractor 447 executes nothing.

Similarly, the second subtractor 448 is arranged such that when the priority value stored in the second priority register 442 is equal to or smaller than the subtraction threshold value “127”, the second subtractor 448 reduces the priority value stored in the second priority register 442 by “1” for every predetermined period of time. When the priority value stored in the second priority register 442 is greater than the subtraction threshold value “127”, the second subtractor 448 executes nothing.

Hereinafter, an outline of operation is described with reference to FIG. 4 and FIG. 11.

At time t0, the priority value 1101 of the first priority register 441 is set to a value “255”, the priority value 1102 of the second priority register 442 is set to a value “255”, and the priority value 1103 of the third priority register 143 is set to a value “20”. Therefore, as a result of arbitration of the bus arbiter 100, a DMA processing 1130 is executed at time t0.

At time t1, an interruption request occurs in the first calculating unit 110, and the interruption processing unit 111 writes a value “9” as the priority value 1101 in the first priority register 441. At this time, the interruption processing unit 111 determines the priority value so that the interruption processing may be completed by time t9. In other words, the priority value which should be written in the first priority register 441 is determined by counting backward from the time t9 that is the deadline of the interruption processing.

Since a value “255” set as the priority value 1102 of the second priority register 442 is larger than the subtraction threshold value “127”, subtraction is not performed. The priority value 1103 of the third priority register 143 is fixed to the value “20”. Therefore, as a result of arbitration of the bus arbiter 100, an I/O access right is given to the interruption request of the first calculating unit 110 with the smallest priority value or the highest priority at time t1. The processor 112 interrupts the regular processing 1110, and executes the interruption processing 1111.

The priority value 1101 of the first priority register 441 is subtracted by “1” for every predetermined period of time after the time t2 until the task is completed.

At time t3, another interruption request occurs in the second calculating unit 120, and the interruption processing unit 121 writes a value “4” as the priority value 1102 in the second priority register 442. This is a setting that the interruption processing completes by the time t6. The priority values stored in each of the priority registers at time t3 are compared, and the bus arbiter 100 arbitrates such that the interruption processing 1121 may be executed. As a result of this arbitration, the interruption processing 1111 is interrupted, the regular processing 1120 is also interrupted, and the interruption processing 1121 is executed.

Then, the priority value 1101 of the first priority register 441 and the priority value 1102 of the second priority register 442 are subtracted by “1” for every predetermined period of time.

At time t6, the interruption processing 1121 is completed, the processor 122 writes a value “255” in the second priority register 442 as the priority value of the regular processing, and the processing 1123 resumes. At this time, the priority value of the first priority register 441 is the smallest, and the bus arbiter 100 arbitrates so that the interruption processing 1112 may be executed. The interruption processing 1112 is continuously executed as a result of this arbitration.

At time t9, the interruption processing 1112 is completed, and the processor 112 writes a value “255” in the first priority register 441 as the priority value of the regular processing, and the processing 1113 resumes. At this time, the priority value of the third priority register 143 is the smallest, and the bus arbiter 100 arbitrates so that the DMA processing 1131 may be executed.

As described above, the real-time processor system of the present embodiment can arbitrate I/O access, in executing a new task including interruption processing, by the rule that permits the new task the I/O access only when no task with higher priority than the new task is in I/O access. Since the priority value of the processing can be set based on task completion time, the scheduling of the I/O access right becomes easy.

The real-time processor system of the present embodiment can be applied by combining with the second embodiment and/or the third embodiment of the present invention, and the combined system may enjoy the effects that the systems in the respective embodiments possess.

In the present embodiment, it is defined that the smaller priority value means the higher priority. When setting the larger priority value to mean the higher priority, the first subtractor 447 and the second subtractor 448 of FIG. 4 may be respectively replaced by adders to perform the same effect as shown above.

### Fifth Embodiment

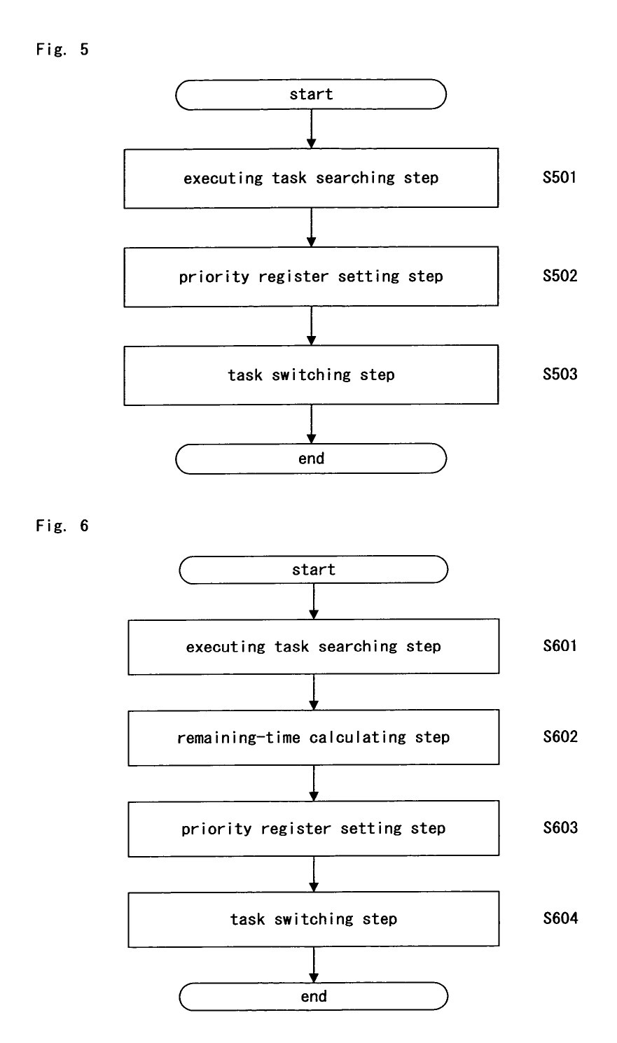

FIG. 5 is a flowchart of a processing of a controlling method according to a fifth embodiment of the present invention. The controlling method of the present embodiment operates on the real-time processor system of the first embodiment through the fourth embodiment of the present invention.

The flowchart of the processing of the controlling method of the present embodiment includes an executing task searching step S501, a priority register setting step S502, and a task switching step S503.

The flow of the processing of the controlling method of the present embodiment is described hereinafter in applying to the real-time processor system shown in FIG. 1.

FIG. 12 is a time chart of the processing of the controlling method according to the fifth embodiment of the present invention. In this example, in the first calculating unit 110 shown in FIG. 1 possesses three tasks; an interruption processing of an I/O access priority “1”, a regular processing A of an I/O access priority “2”, and a regular processing B of an I/O access priority “3”. These three tasks are managed by the OS of the processor 112. Hereinafter, an outline of operation is described with reference to FIG. 1 and FIG. 12.

At time to, the regular processing A is in “WAIT” state (there is no processing to execute and the task is in a waiting state), and the regular processing B is in “RUN” state (the task is under execution), and executes a task 1214. The first priority register 141 possesses a priority value “3” at this time.

At time t2, when an interrupt occurs, the interruption processing unit 111 notifies the interruption occurrence to the processor 112, and writes a priority value “1” in the first priority register 141. The OS of the processor 112 traps the interruption, changes the task 1214 under execution to “READY” state (a state of waiting for execution), and executes an OS processing 1221. The bus arbiter 100 arbitrates a bus and grants an I/O access right to the interruption processing.

A task 1211 of the interruption processing is executed at time t3.

At time t4, a system call is executed for “WAKE-UP” (release from “WAIT” state) of the regular processing A, and the OS of the processor 112 executes an OS processing 1222, and changes the regular processing A into “READY” state.

At time t5, a task 1212 of the interruption processing is executed and is completed.

At time t6, with completion of the task 1212, a system call for the interruption processing completion is executed, and the processor 112 executes an OS processing 1223. A task with the highest priority (the smallest priority value) is searched among the tasks in “READY” state by an OS processing 1223. This corresponds to the executing task searching step S501 shown in FIG. 5.

As a result of the search, the regular processing A is selected and the priority value “2” of the regular processing A is written in the first priority register 141 by the processor 112. This corresponds to the priority register setting step S502 shown in FIG. 5.

The bus arbiter 100 arbitrates the bus and grants an I/O access right to the regular processing A. The processor 112 performs task switching and changes a task 1213 of the regular processing A to “RUN” state to execute. This corresponds to the task switching step S503 of a task shown in FIG. 5.

At time t9, the task 1213 is completed, a system call for a processing completion is executed, and the processor 112 executes an OS processing 1224. The regular processing A is changed to “WAIT” state by the OS processing 1224, and a task with the highest priority (the smallest priority value) is searched among the tasks of “READY” state. This corresponds to the executing task searching step S501 shown in FIG. 5.

As a result of the search, the regular processing B is selected and the priority value “3” of the regular processing B is written in the first priority register 141 by the processor 112. This corresponds to the priority register setting step S502 shown in FIG. 5.

The bus arbiter 100 arbitrates the bus and grants an I/O access right to the regular processing B. The processor 112 performs task switching and changes a task 1215 of the regular processing B into “RUN” state to execute. This corresponds to the task switching step S503 shown in FIG. 5.

By the controlling method of the present embodiment, as described above, after execution of a task is completed, a system call is executed, a task with the highest priority is searched out of executable tasks, the priority register is set based on the priority value of the searched task, and task switching is performed.

To describe the task switching step S503 more concretely, the content of the register that the task currently under execution uses is evacuated on the memory, the content of the register that the searched task is to use is returned from the memory; thereby task switching is performed.

By using the controlling method of the present embodiment, a task and application software called interruption handler can be described independently of the construction of the hardware; thereby development of application software with high portability becomes possible.

### Sixth Embodiment

FIG. 6 is a flowchart of a processing of a controlling method according to a sixth embodiment of the present invention. The controlling method of the present embodiment operates on the real-time processor system of the fourth embodiment of the present invention.

The flowchart of the processing of the controlling method of the present embodiment includes an executing task searching step S601, a remaining-time calculating step S602, a priority register setting step S603, and a task switching step S604.

The flow of the processing of the controlling method of the present embodiment is described hereinafter in applying to the real-time processor system shown in FIG. 4.

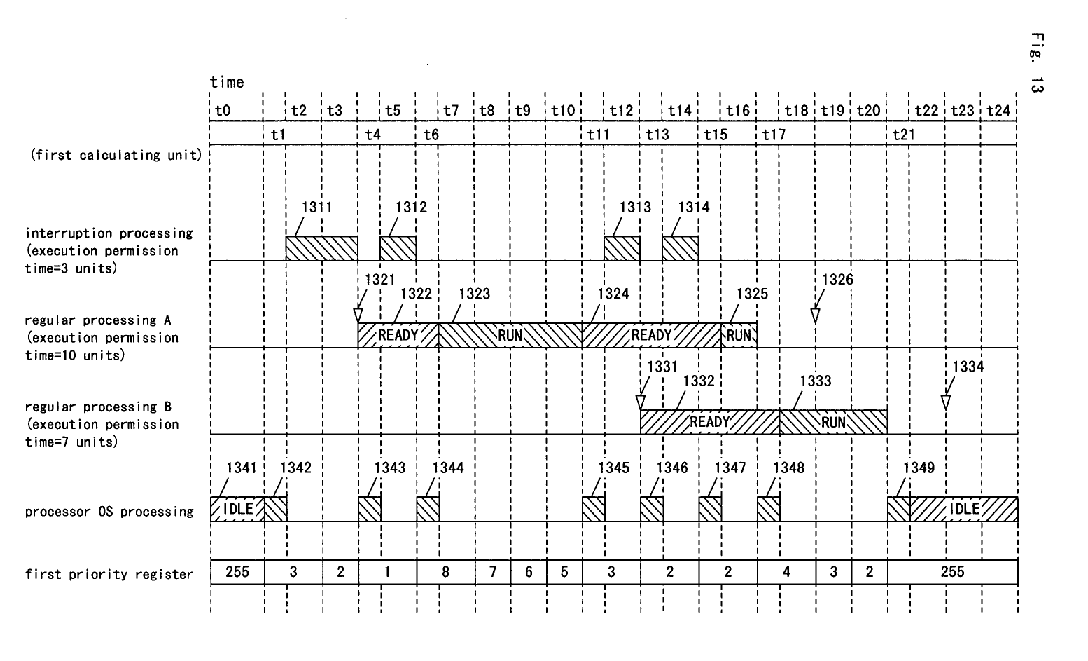

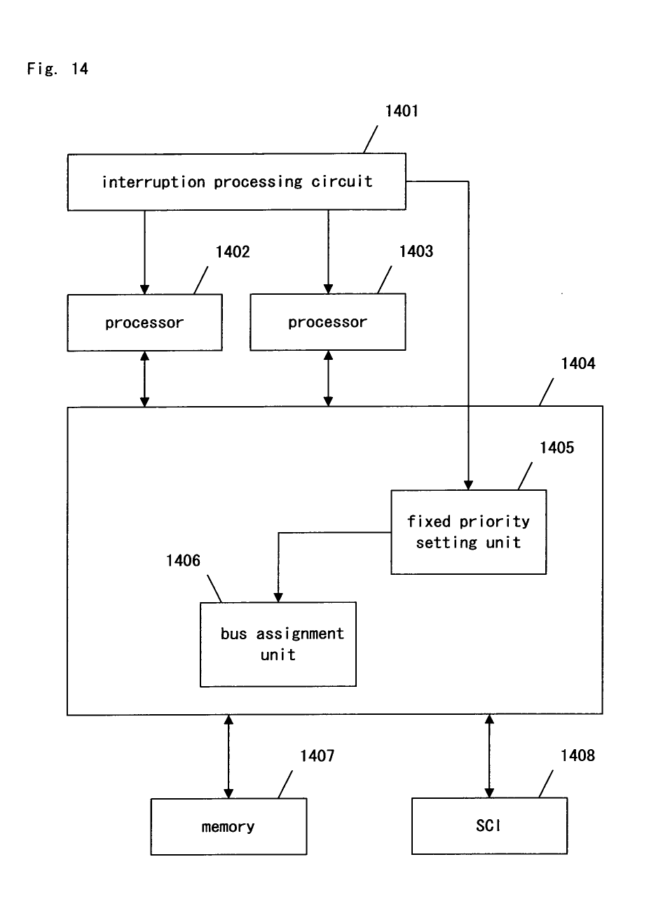

FIG. 13 is a time chart of the processing of the controlling method according to the sixth embodiment of the present invention. This example describes the controlling method of the present embodiment as what is operated on the real-time processor system of the fourth embodiment of the present invention shown in FIG. 4. Therefore, FIG. 4 and FIG. 13 are referred to in the following description.

The example shown in FIG. 13 corresponds to a case where two tasks of interruption processing and two tasks of regular processing are performed in the first calculating unit 110. In this case, it is assumed that the execution permission times of the interruption processing, the regular processing A, and the regular processing B are, respectively, 3 units in time, 10 units in time, and 7 units in time. One unit in time is, for example, 1 ms. The horizontal axis of this time chart shown in FIG. 13 expresses time; however, the length of the horizontal axis is not necessarily proportional to the unit time.

At time t0, an OS processing 1341 of the processor 112 is in “IDLE” state (a state in an idling loop), and a priority value “255” is stored in the first priority register 441. Since the priority value “255” is larger than the subtraction threshold value “127”, the priority value will not be subtracted by the first subtractor 447.

At time t1, an interruption request occurs in the first calculating unit 110, and the interruption processing unit 111 writes a priority value “3” in the first priority register 441. At this time, the interruption processing unit 111 takes into consideration that the execution permission time of the interruption processing is 3 units in time, and determines the priority value which should be written in the first priority register 441 so that the interruption processing may be completed by the time t5. The processor 112 traps the interruption, and executes an OS processing 1342. The bus arbiter 100 arbitrates the bus and grants an I/O access right to the interruption processing.

An interruption processing 1311 is executed at time t2 to t3. In the meantime, the priority value stored in the first priority register 441 is subtracted by “1” for every predetermined period of time.

At time t4, a system call which starts a task of the regular processing A is made, and the processor 112 executes an OS processing 1343 and sets the regular processing A to “READY” 1322.

At time t5, an interruption processing 1312 is executed succeedingly.

At time t6, the interruption processing 1312 is completed, an OS processing 1344 is executed, and a priority value “8” is written in the first priority register 441. At this time, the processor 112 takes into consideration that the execution permission time of the regular processing A is 10 units in time, and determines the priority value which should be written in the first priority register 441 so that the interruption processing may be completed by time t18.

In FIG. 13, an inversed triangle 1321 is a starting time of the regular processing A, and an inversed triangle 1326 is the deadline when delay in processing of the regular processing A is permissible. The period between the inversed triangle 1321 and the inversed triangle 1326 is equivalent to 10 units in time, which is an execution permission time of the regular processing A. The bus arbiter 100 arbitrates the bus and grants an I/O access right to the regular processing A.

At time t7, the regular processing A is set to “RUN” 1323 and a task is executed.

At time t11, a new interruption request occurs in the first calculating unit 110, and the interruption processing unit 111 writes a priority value “3” in the first priority register 441. This priority value is a determined value which is taken into consideration that the execution permission time of the interruption processing is 3 units in time. The processor 112 traps the interruption, executes an OS processing 1345 and sets the regular processing A to “READY” 1324. The bus arbiter 100 arbitrates the bus and grants an I/O access right to the interruption processing.

An interruption processing 1313 is executed at time t12.

At time t13, a system call which starts a task of the regular processing B is made, and the processor 112 executes an OS processing 1346 and sets the regular processing B to “READY” 1332.

At time t14, an interruption processing 1314 is executed succeedingly.

At time t15, the interruption processing 1314 is completed, an OS processing 1347 is executed, and a priority value “2” is written in the first priority register 441. This priority value is a value which is written in at time t7, as the priority value for the regular processing A and is subtracted along with time. The bus arbiter 100 arbitrates the bus and grants an I/O access right to the regular processing A.

At time t16, a task 1325 of the regular processing A is executed.

At time t17, the task 1325 of the regular processing A is completed, an OS processing 1348 is executed, and a priority value “4” is written in the first priority register 441. This priority value is the value which is determined at time t13, as a priority value for the regular processing B and then after subtracted along with time.

In FIG. 13, an inversed triangle 1331 is a starting time of the regular processing B, and an inversed triangle 1334 is the deadline when delay in processing of the regular processing B is permissible. The period between the inversed triangle 1331 and the inversed triangle 1334 is equivalent to 7 units in time, which is an execution permission time of the regular processing B. The bus arbiter 100 arbitrates the bus and grants an I/O access right to the regular processing B.

At time t18, the regular processing B becomes “RUN” state and a task 1333 is executed.

At time t21, the task 1333 is completed, an OS processing 1349 is executed, and a priority value “255” is written in the first priority register 441.

At time t22, the processor 112 becomes “IDLE” state.

In the controlling method of the present embodiment, the completion of one task leads to another searching for the following execution task. In the example shown in FIG. 13, searching of the following execution task is performed at time t6, t15 and t17.

At time t6, a task with the deadline time nearest to the current time is searched out of executable tasks (it corresponds to the executing task searching step S601 shown in FIG. 6). Next, remaining time to the deadline time at the current time is calculated (it corresponds to the remaining-time calculating step S602 shown in FIG. 6). The I/O access priority value (the priority value in this case is a value “8”) corresponding to the calculated remaining time is written in the first priority register 141 (it corresponds to the priority register setting step S603 shown in FIG. 6). Finally, the register used by the task currently under execution is evacuated on the memory, by returning the content of the register that the task to be executed from now on is to use from the memory; thereby task switching is performed and a task 1323 is executed at time t7 (it corresponds to the task switching step S604 shown in FIG. 6).

The processing at time t15 or t17 is also the same.

As described above, in the controlling method of the present embodiment, grant of an I/O access right is performed based on a priority value which is proportional to permission time until a task of a regular processing or a task of an interruption processing completes.

The fixed priority method as described in the fifth embodiment is widely used because of the simple schedule calculation. However, as exemplified in the present embodiment, when executing by the processors with the same processing speed, scheduling that takes into consideration the permission time to the completion of the processing can shorten time to the completion of processing in the worst case.

The controlling method which adopts the dynamic priority method as described by the present embodiment can be extended to multi-processor environment.

The first calculating unit 110 and the second calculating unit 120 in the embodiments except the second embodiment of the present invention described above may be substituted by the first calculating unit 210 and the second calculating unit 220 in the second embodiment of the present invention.

In the first embodiment through the sixth embodiment of the present invention, the calculating units is two pieces, more number of the calculating units may be used. In that case, when the number of priority registers is also increased along with the number of calculating units, the same effect can be acquired as in the first embodiment through the sixth embodiment of the present invention.

The third priority register 143 in the first embodiments through the sixth embodiment of the present invention stores the fixed value; however, it may store a variable value under control of the DMA controller 130.

In short, in the range which does not deviate from the purpose of the present invention, various extensions are possible.

According to the present invention, it is possible to provide, in the environment where a plurality of bus masters arbitrate and use a bus, a real-time processor system and controlling method comprising a separate interruption processing means for every bus master and operable to adaptively control bus arbitration priority for multiple interruption and processing other than the interruption processing.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A real-time processor system comprising:
a plurality of function groups;
a bus arbiter; and
at least one I/O device operable to connect to said bus arbiter,
wherein each of said plurality of function groups comprises:
a calculating unit comprising a processor and an interruption processing unit, said calculating unit being operable to connect to said bus arbiter; and
a priority register operable to store either one of an I/O access priority value for ordinary processes by said processor and an I/O access priority value for interruption processes by said interruption processing unit, and
wherein said bus arbiter comprises:
a priority comparing unit operable to compare a plurality of priority values respectively stored in said priority register of each of said plurality of function groups, thereby outputting a comparison result; and
a bus assignment unit operable to decide access right to a bus based on the comparison result.

2. A real-time processor system comprising:
at least one function group;
a bus arbiter;
at least one I/O device operable to connect to said bus arbiter,
a bus access generation unit operable to connect to said bus arbiter and to actively generate bus access; and
a first priority register operable to store a bus access priority value for said bus access generation unit,
wherein said at least one function group comprises: a calculating unit comprising a processor and an interruption processing unit, said calculating unit being operable to connect to said bus arbiter; and
a second priority register operable to store either one of an I/O access priority value for ordinary processes by said processor and an I/O access priority value for interruption processes by said interruption processing unit, and
wherein said bus arbiter comprises:
a priority comparing unit operable to compare a priority value stored in said first priority register with a priority value stored in said second priority register to output a comparison result; and
a bus assignment unit operable to decide access right to a bus based on the comparison result.

3. A real-time processor system comprising:
at least one function group;
a bus arbiter;
at least one I/O device operable to connect to said bus arbiter;
a bus access generation unit operable to connect to said bus arbiter and to actively generate bus access; and
a first priority register operable to store a bus access priority value for said bus access generation unit,
wherein said at least one function group comprises:
a calculating unit comprising a processor and an interruption processing unit, said calculating unit being operable to connect to said bus arbiter;
a second priority register operable to store either one of an I/O access priority value for ordinary processes by said processor and an I/O access priority value for interruption processes by said interruption processing unit; and
a comparison storing unit operable to compare an I/O access priority value for interruption processes by said interruption processing unit with an I/O access priority value stored in said second priority register, said comparison storing unit further being operable to store the I/O access priority value for the interruption processes by said interruption processing unit into said second register only when the I/O access priority value for the interruption processes by said interruption processing unit indicates higher priority than the I/O access priority value that has been stored in said second register, and
wherein said bus arbiter comprises:
a priority comparing unit operable to compare a priority value stored in said first priority register with a priority value stored in said second priority register to output a comparison result; and
a bus assignment unit operable to decide access right to a bus based on the comparison result.

4. A real-time processor system comprising:
at least one function group;
a bus arbiter;
at least one I/O device operable to connect to said bus arbiter;
a bus access generation unit operable to connect to said bus arbiter and to actively generate bus access; and
a first priority register operable to store a bus access priority value for said bus access generation unit,
wherein said at least one function group comprises:
a calculating unit comprising a processor and an interruption processing unit, said calculating unit being operable to connect to said bus arbiter;
a second priority register operable to store either one of an I/O access priority value for ordinary processes by said processor and an I/O access priority value for interruption processes by said interruption processing unit; and
a priority changing unit operable to change as time passes the I/O access priority value stored in said second priority register so that the I/O access priority value stored in said second priority register indicates higher priority, and
wherein said bus arbiter comprises:
a priority comparing unit operable to compare a priority value stored in said first priority register with a priority value stored in said second priority register to output a comparison result; and
a bus assignment unit operable to decide access right to a bus based on the comparison result.

5. A real-time processor system as claimed in claim 1, wherein said calculating unit of each of said plurality of function groups further comprises a storing unit operable to store into said priority register an I/O access priority value uniquely determined by an interruption factor.

6. A real-time processor system as claimed in claim 5, wherein said storing unit comprises a group of priority setting registers, one of said priority setting registers pre-storing an I/O access priority value that is program-controlled by said processor, and another of said priority setting registers pre-storing an I/O access priority value that is determined by an interruption factor, and
wherein, only when a new interruption is requested and an I/O access priority value determined by an interruption factor of the new interruption indicates higher priority than a priority value of an interruption under processing, said storing unit stores into said priority register the I/O access priority value determined by the interruption factor of the new interruption.

7. A controlling method for a real-time processor system, the controlling method comprising:
searching a task to be next performed;
storing, in a priority register corresponding to an executing processor, an I/O access priority value of the task detected in said searching; and
changing a current task to the task detected in said searching.

8. A controlling method as claimed in claim 7, wherein the real-time processor system comprising:
a plurality of function groups;
a bus arbiter; and
at least one I/O device operable to connect to said bus arbiter,
wherein each of said plurality of function groups comprises:
a calculating unit comprising a processor and an interruption processing unit, said calculating unit being operable to connect to said bus arbiter; and
a priority register operable to store either one of an I/O access priority value for ordinary processes by said processor and an I/O access priority value for interruption processes by said interruption processing unit, and
wherein said bus arbiter comprises:
a priority comparing unit operable to compare a plurality of priority values respectively stored in said priority register of each of said plurality of function groups, thereby outputting a comparison result; and
a bus assignment unit operable to decide access right to a bus based on the comparison result.

9. A controlling method for a real-time processor system, the controlling method comprising:
searching a task to be next performed;
calculating a remaining time that is a time difference between a dead line corresponding to the task detected in said searching and a current time;
storing, in a priority register corresponding to an executing processor, an I/O access priority value corresponding to the remaining time calculated in said calculating; and
changing a current task to the task detected in said searching.

10. A controlling method as claimed in claim 9, wherein the real-time processor system comprising:
a plurality of function groups;
a bus arbiter; and
at least one I/O device operable to connect to said bus arbiter,
wherein each of said plurality of function groups comprises:
a calculating unit comprising a processor and an interruption processing unit, said calculating unit being operable to connect to said bus arbiter; and
a priority register operable to store either one of an I/O access priority value for ordinary processes by said processor and an I/O access priority value for interruption processes by said interruption processing unit, and
wherein said bus arbiter comprises:
a priority comparing unit operable to compare a plurality of priority values respectively stored in said priority register of each of said plurality of function groups, thereby outputting a comparison result; and
a bus assignment unit operable to decide access right to a bus based on the comparison result,
wherein said calculating unit of each of said plurality of function groups further comprises a storing unit operable to store into said priority register an I/O access priority value uniquely determined by an interruption factor,
wherein said storing unit comprises a group of priority setting registers, one of said priority setting registers pre-storing an I/O access priority value that is program-controlled by said processor, and another of said priority setting registers pre-storing an I/O access priority value that is determined by an interruption factor, and
wherein, only when a new interruption is requested and an I/O access priority value determined by an interruption factor of the new interruption indicates higher priority than a priority value of an interruption under processing, said storing unit stores into said priority register the I/O access priority value determined by the interruption factor of the new interruption.
